(19) United States
(12) Patent Application Publication
(10) Pub. No.: US 2005/0240452 A1
(43) Pub. Date: Oct. 27, 2005

(54) System and method of making travel arrangements

(76) Inventors: Johnnie C. Breed, Longboat Key, FL (US); Charles Speranzella, Tampa, FL (US); Kurt R. Hoehn, Orange Park, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/094,340

(22) Filed: Mar. 30, 2005

Related U.S. Application Data
(60) Provisional application No. 60/558,337, filed on Mar. 30, 2004.

(51) Int. Cl. G06F 17/60

(52) U.S. Cl. 705/5

(57) ABSTRACT

A method of making travel arrangements is provided where the travel arrangements may be made among an ordering agency and a plurality of ordering stations that are interconnected in a Web-based environment over a communications medium. The method may include creating a first electronic ticket order at an ordering station. The first electronic ticket order may be transmitted over the telecommunications medium from the ordering station to the ordering agency, which may approve the first electronic ticket order. An electronic notification may be transmitted to the ordering station indicating that the first electronic ticket order has been approved. The ordering station may accept the first electronic ticket order and assigning a ticket to a passenger. A ticket may be printed at the ordering station for delivery to the passenger.

### CROSS REFERENCE TO RELATED APPLICATIONS

This application claims the benefit of the prior filed Provisional Patent Application having Application No. 60/558,337 and filing date of Mar. 30, 2004.

### FIELD OF THE INVENTION

This invention relates in general to making transportation arrangements and in particular to a computer-implemented system and method for requesting, authorizing, scheduling and managing travel arrangements in an interactive Web-based telecommunications environment for a plurality of passengers among a plurality of transportation carriers.

### BACKGROUND OF THE INVENTION

In a traditional environment for making travel arrangements a travel agent may receive a travel request from an entity authorizing the travel, which may be for one or a plurality of travelers. The travel agent will use whatever resources they have at their disposal and book travel arrangements for each individual. The communication requirements among the various entities involved present an array of challenges in managing the process efficiently. Selecting the best routes and fares so that the customer is assured that the most cost effective and efficient routes are booked may also lead to delays and unnecessary costs. When there are a large number of travelers either departing from the same place or arriving at the same place the problems associated with purchasing tickets and scheduling travel for the individual passengers becomes even more difficult to manage efficiently using traditional methods.

### BRIEF SUMMARY OF THE INVENTION

Features and aspects of the invention may be implemented in numerous ways including but not limited to as a system, a method, a computer site such as an application service provider, or a computer readable medium. Conventional programming languages and protocols may be used implementing embodiments of the invention over a communications medium such as the Internet.

Aspects of the invention may be used as a complete online travel management system. User interface portions or modules may be designed to run on any computer with a modern Web browser such as the latest versions of Microsoft Internet Explorer®, Netscape Navigator® and Mozilla®. Adobe Acrobat Reader® may be used as a browser helper program for displaying reports generated by modules of the invention. HTTP protocol may be used for the core communication protocol and may be used to deliver Web-based information from a server to a user's personal computer in HTML. Session cookies may be used to track user's sessions and transactions. A database engine may be provided to store and retrieve dynamic data and metadata from an appropriately configured database. An application module or engine may be used to process business logic and generate dynamic HTML pages as well as control data flow and program execution. A Web server may be used to display HTML pages to the end users via their respective Web browsers. The database engine, application engine, and Web server may each be comprised of multiple servers in various localized or remote locations.

Other components common to Web applications and/or Web sites may be used such as Domain Naming System (DNS) maps and Uniform Resource Locators (URLs) to Internet protocol addresses. A Mail Transfer Agent (MTA) may process electronic mail for notifications and other alerts. The Network Time Protocol (NTP) may be used to synchronize the time with atomic clocks running on NTP servers on the Internet. Other commercially available components may be used for security and monitoring.

Embodiments of the invention may provide customers with an automated and streamlined system and method of booking transportation for their clients or customers. This helps reduce the time and effort required by customers to complete the booking process and helps to reduce errors and costs associated with phone calls, faxes, missed schedules, improper allocation of funds, packaging and shipping, and a multitude of other possible inefficiencies associated with traditional processes. One aspect allows for real-time information and feedback on fares and schedules to be provided to a user so they may make informed travel and budgetary decisions.

In one aspect a centralized budget office or ordering agency may control the travel funds for a specific organizational entity having a plurality of geographically dispersed offices or ordering stations. The ordering stations may book travel arrangements for their respective clients or customers through the ordering agency, which may have ultimate budget authority. The ordering agency and stations may be provided with continually updated information about fares and schedules with respect to ground and air carriers and are enabled to confirm booking, pay electronically, and generate their own tickets and itineraries on demand. Also, carriers may be notified of confirmed bookings and funds so they may schedule their resources and use travel manifests generated by an ordering agency or station and transmitted to the carriers.

Another aspect allows immediate credit card reconciliation of an ordering agencies' expenditures and credits, which allows that agency to ensure that it remains within budget constraints. It also allows an ordering agency to consider the reallocation of bulk tickets among entities such as from one ordering station to another within its scope of responsibility. Credit card reconciliation records may be managed and maintained in a database by an application or processing module. As purchases are made or refunds returned, the credit card reconciliation database may be updated to reflect the current state of credit card transactions in real-time. This allows a user to reconcile transactions in real-time rather than waiting for a monthly credit card statement before reconciling an account. A reporting module allows both the ordering agency and stations to generate full accounting reports of their respective transactions.

### BRIEF DESCRIPTION OF THE DRAWINGS

The invention will be more apparent from the following description in view of the drawings that show:

FIG. 1 is a schematic of an exemplary communications medium that may be used for implementing embodiments of the invention.

FIG. 2 is a flow diagram of one aspect of an exemplary method of the invention.

FIG. 3 is a flow diagram of one aspect of an exemplary method of the invention.

FIG. 4A is a portion of a flow of one aspect of an exemplary method of the invention.

FIG. 4B is a second portion of the flow diagram of FIG. 4A.

FIG. 5 is a portion of a flow diagram of one aspect of an exemplary method of the invention.

FIG. 6 is a graphical user interface of an exemplary station profile.

FIG. 7 is a graphical use interface of an exemplary ticket log.

### DETAILED DESCRIPTION OF THE INVENTION

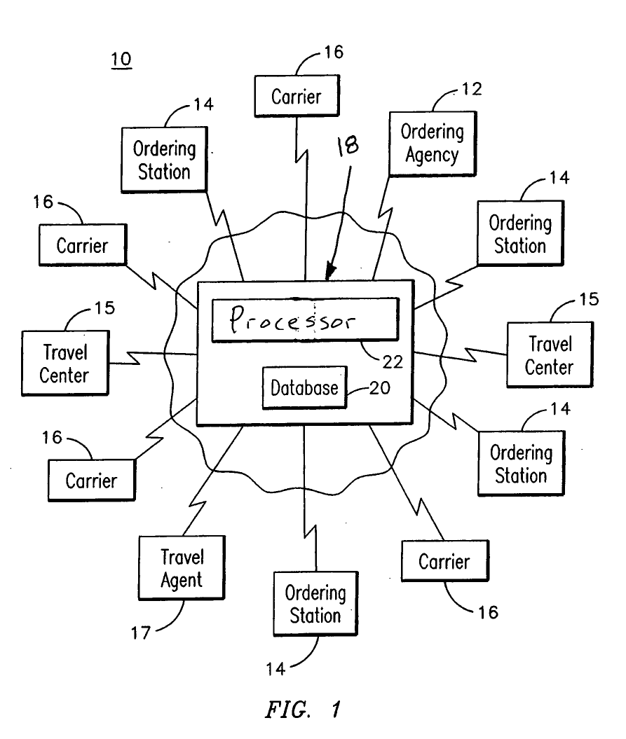

FIG. 1 illustrates an exemplary communications medium 10 over which exemplary methods of the present invention may be implemented. One exemplary embodiment may include interconnectivity for the transmission and exchange of electronic data among a host or ordering agency 12, remote ticket ordering stations 14, travel centers 15, transportation providers or carriers 16, a travel agent 17 and at least one server 18 operable with a database 20. Various combinations of ordering agencies 12, ticket ordering stations 14, travel centers 15, carriers 16, travel agents 17, servers 18, database 20 and a processing or control module 22 may be used in accordance with aspects of the invention. One or more modules 22 may be used for data management and executing and controlling aspects of the invention, which may reside on server 18 or at any appropriately configured remote location.

Prior filed Provisional Patent Application having Application No. 60/558,337 and filing date of Mar. 30, 2004 is specifically incorporated herein by reference for the teachings and disclosures contained therein.

Conventional hardware, software and communications protocols may be used as will be recognized by those skilled in the art for implementing embodiments of the invention. For example, server 18 may be an Intel-based application server and database 20 may be an appropriately configured Oracle database. Exemplary embodiments may use multiple servers 18 and/or databases 20 in various combinations at one or more remote or centralized locations and may be configured with architecture for operation within a Web-based communications medium 10, which may be the Internet and may include wireless communications such as microwave and satellite, for example.

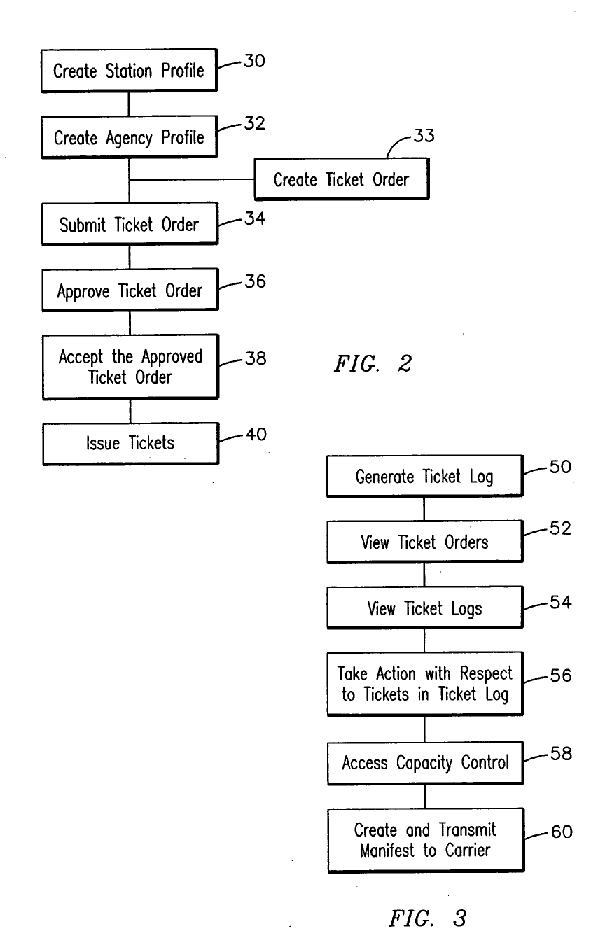

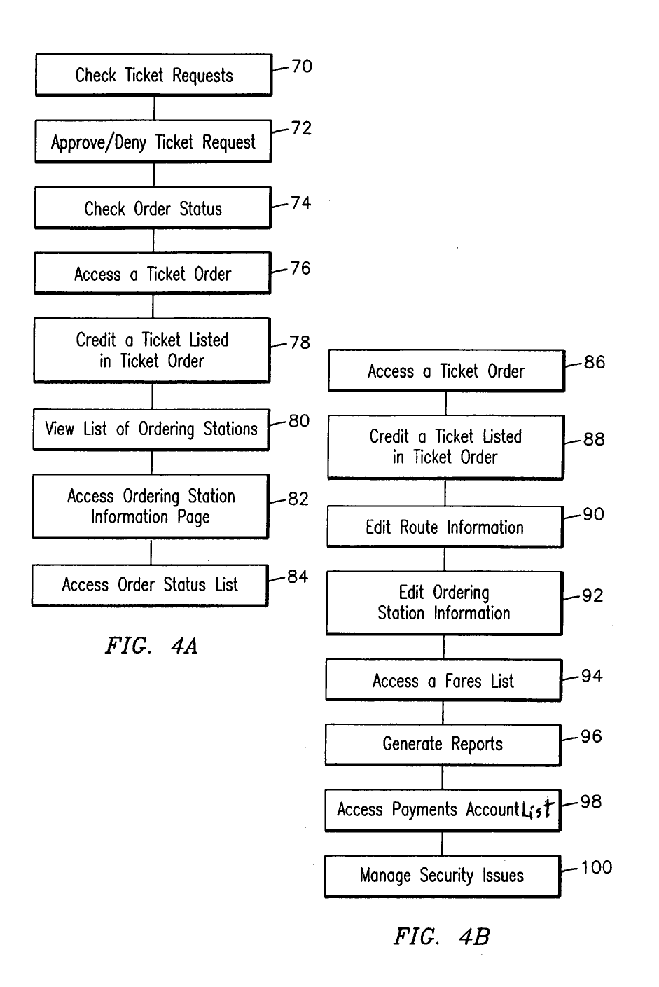

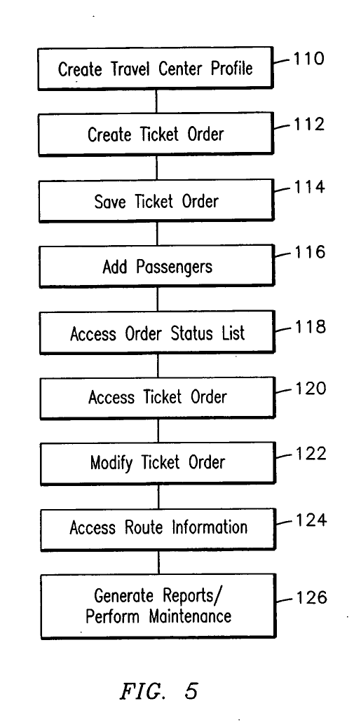

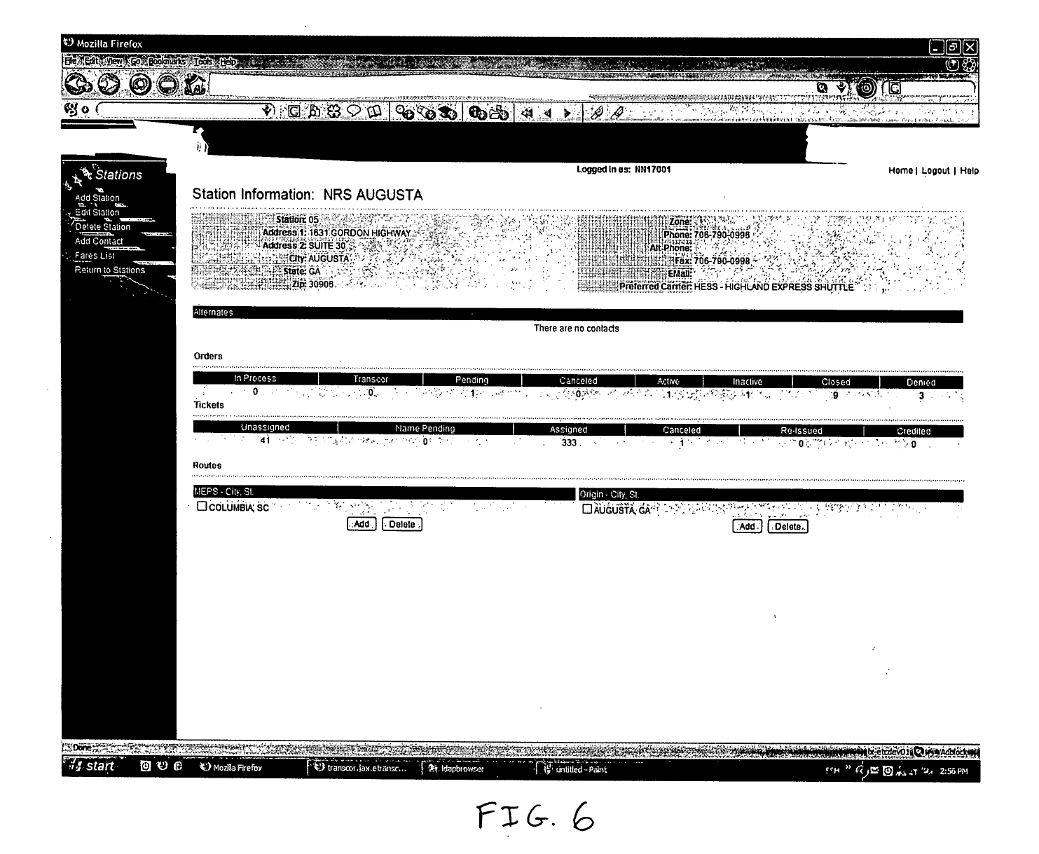

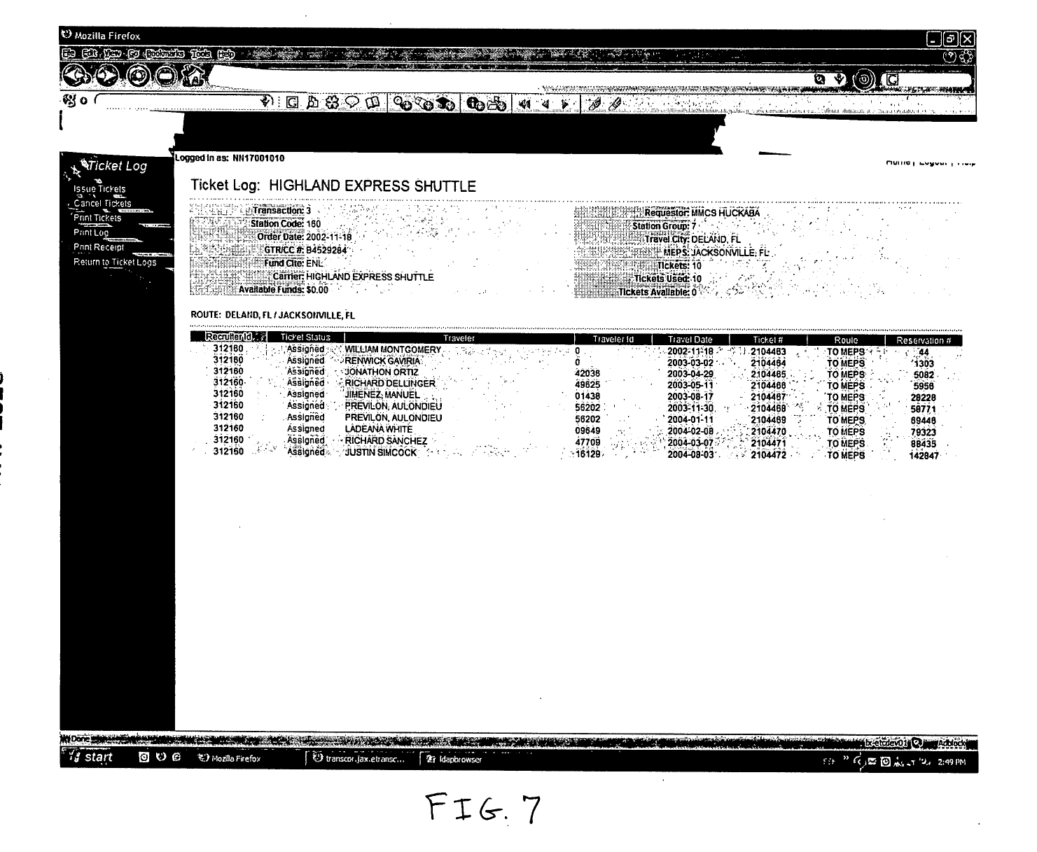

FIG. 2 illustrates exemplary steps with respect to one aspect of the invention. Step 30 allows a profile to be created for an ordering station 14 using processor 22 and stored in database 20. The profile may include a unique identifier, an address, contact information, an identifier for the regional or geographic location of the station 14 such as a zone number and a preferred carrier for transporting passengers from a point of origin to a point of destination. The profile may be created by an associated ordering agency 12 using an appropriately configured user interface that may be presented as a Web page in a conventional Web browser on a personal computer. It will be recognized that various aspects of the invention may employ a range of graphical user interface configurations for inputting data into and retrieving data from an application module or modules executable by processor 22 that may store and retrieve appropriate data from database 20.

When creating a profile for an ordering station 14 in step 30, a preferred carrier, such as a rail or other ground transportation provider, may be selected from a pull down menu of predetermined regional and/or national carriers that may serve that ordering station 14. An ordering agency 12 may have budget authority for one or more ordering stations 14 within its scope of responsibility or management. Each ordering station 14 may order tickets and schedule transportation for passengers within that station's geographical scope of authority.

One or more points of origin and points of destination may be located within an ordering station's 14 geographical scope and defined by an ordering station as part of their station profile. For example, a station 14 may order tickets and schedule transportation for a plurality of passengers that are to be picked up at different points of origin and delivered to the same point of destination. Other combinations will be appreciated. In one aspect, tickets ordered by an ordering station 14 may be associated with that ordering station 14 for various purposes such as issuing the tickets and creating a ticket log described herein.

Step 32 allows a profile to be created and stored in database 20 for an ordering agency 12 that may include an agency name, a unique identifier, an address, contact information, an identifier for the regional or geographic district of the agency 12 and a fund profile. In one aspect of the invention an ordering agency 12 may communicate interactively over communications medium 10 with one or more ordering stations 14 within its scope of responsibility and associated carriers 16. Each ordering station 14 may communicate interactively over communications medium 10 with one or more carriers 14 serving transportation routes within the geographical scope of a respective ordering station 14. Such interactive communications and other forms of data exchange may be executed via Web-based tools and protocols as appreciated by those skilled in the art.

One aspect of the invention allows a hierarchy to be established for collecting, analyzing and presenting historical data with respect to scheduling and/or transportation related events associated with an ordering agency 12 and associated ordering stations 14 and carriers 16. For example, an embodiment of the invention may be used for providing ticketing, scheduling and transportation services to a military branch of the Federal government or other agency. In this respect, a military branch may be of the highest order followed by a subordinate geographical region of the country, which may include a plurality of subordinate ordering agencies 12 within that region. Each ordering agency 12 may include a plurality of subordinate ordering stations 14, which may be a recruiting office of a respective military branch, for example.

Further, each ordering station 14 may include a plurality of subordinate carriers 16 or other modes of transportation, which may be commercial transportation providers such as buses, airlines, trains, shuttles and/or chartered transportation services. This exemplary hierarchy allows historical data to be compiled and presented to the military branch and/or respective carriers 16, for example, for their use in optimizing the number of ordering stations 14 within an ordering agency 12 or for optimizing routes and/or vehicle utilization by a respective carrier 16. Other uses for such data will be recognized by those skilled in the art.

Step 33 allows a ticket request or order to be created by a user for the purchase of tickets for any mode of transportation. A ticket order may be for a single ticket, or for a bulk quantity of tickets with each ticket to be purchased at the same price. A ticket order may originate from an ordering agency 12, an ordering station 14 or a travel center 15. An ordering agency 12 may create a ticket order for any ordering station 14 within its scope of responsibility or a station 14 may order tickets on its own behalf. Step 34 allows a ticket order to be submitted such as from an ordering station 14 to an associated ordering agency 12. For example, a ticket order may be created electronically in step 33 at an ordering station 14 and transmitted using a conventional Web browser over communications medium 10 to an ordering agency 12. A user at an ordering station 14 may activate a ticket ordering Web page from a local personal computer that may be pre-populated with ordering station 14 specific data and contain dialogue boxes for the user to enter data with respect to the ticket order.

An ordering agency 12 and travel center 15 may have budget authority for purchasing tickets within their respective scopes of responsibility. After submitting a ticket order, the ticket order may be approved or rejected by an ordering agency 12 in step 36 based on predetermined criteria such as the availability of funds or ticket price, or other desired criteria. When a ticket order is approved an ordering agency 12 may reserve a budget amount based on a ticket price and quantity of tickets in the ticket order. Payment for the ticket order may be made in various manners including charging a centrally billed account, credit cards issued to a regional authority, using a GTR account or otherwise charging an amount equal to a reserved budget amount. In one aspect, ordering agencies 14 may manage payments and credits and ordering stations 14 may not be provided with that authority.

An ordering agency 12, ordering station 14 or travel center 15 may order tickets and schedule transportation for one or more modes of transportation depending on travel parameters such as the geographical location of or distance between a city of origin and city of destination (O/D Pair). For instance, a passenger may be scheduled to take ground transportation from a city of origin to an airport for further travel by airplane to a city of destination. Tickets may be ordered and transportation scheduled for both modes of transportation by a user at ordering agency 12, ordering station 14 or travel center 15.

In an embodiment the mode or modes of transportation may be selected based on a category of passenger. One aspect of the invention allows a user at a travel center 15, for example, to associate passengers with an exemplary category such as initial input, graduation, termination, miscellaneous or administrative leave, summer/winter break or transfer. If a passenger is associated with “termination” for instance then that passenger may be scheduled for a predetermined mode of transportation such as by bus. Each category may be associated with one or more modes of transportation as selected by the travel center 15 or other entity making the travel arrangements and/or purchasing tickets.

One aspect allows electronic mail notifications to be automatically created and transmitted on the occurrence of certain events such as a ticket order being transmitted and/or a ticket order being approved or rejected. In this respect, electronic mail notifications may be received by a user via a personal digital assistant (PDA) or other suitable device without the user having to be logged into an application program executing aspects of the invention, or being logged into the communications medium 10. Step 38 allows a ticket order approved in step 36 to be accepted or rejected by a user at a respective ordering station 14 that created and submitted the ticket order. A ticket order created at an ordering agency 12 may be transmitted to the respective ordering station 14 for acceptance or rejection in step 38.

After accepting a ticket order in step 38, a user at ordering station 14 may take action with respect to each ticket within the ticket order. A user may associate a status with each ticket within the ticket order via a ticket log as disclosed herein. For example, a ticket within the order may be issued to a respective passenger in step 40 and given the status of Assigned. In one aspect of the invention, each ticket within a ticket order submitted from an ordering station 14 to an ordering agency 12 may be associated with a unique status of:

Unassigned—the ticket has never been assigned “new ticket” and cannot be canceled or printed but may be assigned by a user at respective ordering station 14 or credited by a user at respective ordering agency 12.

Name Pending—the ticket may be printed, canceled and assigned but cannot be credited and a ticket log (discussed below) may not be closed until the ticket has achieved final disposition such as being assigned. A pending ticket counts against or is deducted from the available ticket quantity.

Assigned—the ticket may be printed and canceled but cannot be credited. It will count against the available ticket quantity.

Canceled—the ticket is no longer valid and cannot be printed or credited. This will adjust the available ticket quantity.

Re-issued—the ticket has been canceled and is available for issue. The ticket can be assigned or credited.

Credited—the ticket has been removed from the ticket log by a user at an ordering agency 12 and the available funds and ticket quantity are adjusted.

Another aspect allows a user at ordering station 14 to use an interactive application program of the invention via a Web browser for executing functions that may be specific to an ordering station 14. For example, a user at an ordering station 14 may order or request tickets, check pending ticket orders, and access ticket logs and a capacity control module.

A ticket order may be created by a user at ordering station 14 by using an interactive Web page having certain fields pre-populated with data specific to the station creating the order. Data fields may also be pre-populated with data specific to an order such as when the user is reordering a block of the same number of tickets for travel between commonly used points of origin and destination. Each ticket order may include a unique identifier for the order, a funding source or site, a unique identifier for the user creating the order, a point of origin, a point of destination, a carrier name and a quantity of tickets. Optional data may be entered by a user such as a department identifier, a code and comments, for example.

Step 50 allows a ticket log to be created by processing module 22 and stored in database 20, which may be in response to a ticket order being accepted in step 38. The ticket log may be automatically generated by processing module 22 after acceptance of an approved ticket order by a user at an ordering station 14. A ticket log may function as a central electronic document for controlling events associated with each ticket within the respective ticket log and may be accessed by a user at ordering station 14 for that purpose. In one aspect, a ticket log may only be created if a fund cite is identified and payment is authorized for the tickets ordered, a valid OD Pair exists and an ordering station 14 profile is created.

Step 52 allows a user at ordering station 14 to access a processing module executable by processor 22 from a menu within an interactive Web page for checking the status of one or more pending ticket orders with respect to that ordering station 14. The pending orders module may retrieve data from database 20 and list and display in a Web page individual ticket orders for the ordering station 14 and may include data specific to each order. The displayed information may include a transaction number, a code for and name of the ordering station 14, a date the ticket order was submitted, a carrier for the order, a point of origin and destination, a quantity and total cost of tickets in the order and a status for the order. The status for each ticket order with respect to an ordering station 14 may include:

In-Process—the ticket order/request has been transmitted to the ordering agency 12.

Pending—the ticket order/request has been approved by the ordering agency 12 but not yet activated/accepted by the user at ordering station 14.

Active—the ticket order/request has been accepted by the user at ordering station 14 and an associated ticket log has been created.

Inactive—the ticket log associated with an order has been closed such as when all tickets within an order have been treated with a final disposition such as being assigned to respective passengers. This status will remain until the ticket log that supersedes it is filled. The ticket log may then be closed.

Step 54 allows a user at ordering station 14 to access a processing module executable by processor 22 from a menu within an interactive Web page for retrieving data from database 20 to review a list of ticket logs with respect to that ordering station 14. Each listed ticket log with respect to ordering station 14 may be displayed in a Web page and may include a unique identifier such as a transaction number, a carrier name, a date the ticket order was transmitted or submitted, a point of origin and destination, a total quantity of tickets ordered, a quantity of tickets remaining for action and a link for reordering or replicating the ticket order for subsequent passengers.

The unique identifier for a ticket log may be a dynamic link that allows a user to access the ticket log, which may be stored in database 20 that may contain information associated with all tickets in the ticket log. For example, the link may allow a user to access an interactive Web page containing information for each ticket listed in the ticket log and take action with respect to those tickets in step 56. The linked information may be displayed in a Web page and may include for each ticket a user identification such as a user's name, a ticket status, a passenger name and identifier, a travel date, a ticket number, a route and a reservation number. The route may identify the point of origin or travel city, or the point of destination where a passenger will be delivered.

A ticket log may also include summary data and unique identifiers such as the transaction number, an identifying code for the respective ordering station 14, an order date, a GTR/CC number, a funding site, a carrier name, an amount of available funds, a group code for the respective ordering station 14, a city of origin and destination, a quantity of total tickets ordered, a quantity of tickets used and a quantity of tickets available. Step 56 allows a user to take action with respect to each ticket listed in the ticket log such as issuing a ticket, canceling a ticket and/or printing a ticket, for example. A user may also print the ticket log and/or a receipt with respect to the associated ticket order.

A user at an ordering station 14 may also use an interactive application program of the invention via a Web browser to access a capacity control module with respect to one or more ticket orders in step 58. The capacity control module allows a user to select a date and review data specific to a route or transportation schedule between at least one city of origin and at least one city of destination. The data may include a carrier name and information, a driver name and contact information, the carrier route, scheduled times for pickups, total number of passengers scheduled for the route on a specific date, and a vehicle type and identification. A carrier route may include passenger pick-ups and/or drop-offs with respect to tickets ordered by more than one ordering station 14. Step 60 allows a passenger manifest to be created and transmitted to a respective carrier over communications medium 10. A manifest may be created electronically and transmitted to a carrier when a ticket order has been completed. A ground transportation driver, for example, may update the manifest over communications medium 10 while driving the carrier route and adjust the route schedule accordingly.

Another aspect of the invention allows a user at an ordering agency 12 to use an interactive application program via a Web browser for executing functions specific to an ordering agency 12. For example, a main menu may be displayed in a Web page and may list functions via links that allow a user at an ordering agency 12 to order tickets, review prepaid tickets, review ticket requests submitted from ordering stations 14 or originating at ordering agency 12, review the status of each ticket order, review a list of ordering stations 14 within the responsibility of a respective ordering agency 12, generate reports, review payment accounts and perform administrative functions. The main menu may also include information identifying the respective ordering agency 12 such as its name, address and contact information.

Categorical listings of the status of ticket orders, status of tickets and funding activity, for example, with respect to all ticket orders submitted from ordering stations 14 to an ordering agency 12 may be presented in the main menu. The status of the total number of ticket orders from ordering stations 14 may be grouped into categories such as in-process, pending, canceled, active, inactive, closed or denied. The number of ticket orders within each category may be displayed with a link that allows the user to access information pertaining to all ticket orders within a status category. The main menu page may display links to administrative functions that may include editing information with respect to the ordering agency 12 and/or respective ordering stations 14, adding/editing fund or ordering station 14 profiles and managing security issues with respect to user access and control.

From the main menu displayed on the interactive Web page, step 70 allows a user at an ordering agency 12 to link to a list of ticket requests submitted from one or more ordering stations 14. The list of ticket requests may include information specific to each request such as a transaction number, identification of the ordering station 14, a request date, a city of origin and city of destination, a route type, a funding cite, a carrier, a status and a quantity of tickets requested/ordered. The user at ordering agency 12 may use a link for accessing a drop down menu or set of prompts for taking action with respect to each ticket request. For example, in step 72 a user may approve or deny a ticket request or print tickets associated with a request. To complete the approval process, the user may enter an account number associated with each ticket request, a number of tickets and any optional comments associated with the transaction.

Step 74 allows a user at an ordering agency 12 to link to an order status list that may list the status of ticket orders associated with each ordering station 14 that is within the responsibility of that ordering agency 12. The order status list may contain information specific to each ticket order from an ordering station 14 such as a transaction number, identification of the ordering station 14 by name or other identifier, an order date, a funding site, a carrier, a city of origin, a city of destination, a status, a reservation indicator (on/off), and a total number and cost of the tickets for that respective order. A pull down menu within the order status list Web page allows a user to sort and list ticket orders by their respective status category such as pending or active, for example. Each ticket order in the list may have a link that allows the user to access and display in a Web page information specific to that ticket order, which may be the associated ticket log generated in step 50 with respect to that ticket order.

From the ticket log Web page a user may execute certain actions with respect to each ticket displayed in the ticket log depending on the status of the associated ticket order. For example, a ticket order having the status of active or inactive may have tickets within that order credited by a user at ordering agency 12 in step 78. A ticket within a ticket order may be credited by activating a link from the associated ticket log Web page. Ticket orders having a status of pending, rejected, closed or denied may not have a ticket within that order credited. A user may also print tickets or ticket receipts for a specific ticket order by activating an appropriate link displayed in the associated ticket log Web page.

The main menu at an ordering agency 12 may include a link to allow a user in step 80 to view a list of ordering stations 14 within that ordering agencies' 14 area of responsibility. Linking to the list of ordering stations 14 allows the user to view information specific to each ordering station 14 that may include a description of each ordering station 14 such as by name or other unique identifier and the station's location and contact information. A link may be provided for each ordering station 14 in the list that allows a user to access more detailed information specific to the linked ordering station 14. Activating the link in step 82 allows the user to view a station information page that may include an identifying code for the selected ordering station 14, a detailed address and contact information, a hierarchy category for the station such as a zone number and a preferred carrier if one has been selected by the ordering station 14.

A summary of ticket orders specific to the selected ordering station 14 may be listed on the station information page by a status category and the number of ticket orders within each status category. A link may be provided within each status category allowing the user to access information specific to each respective ticket order having the selected status category. For example, each ticket order associated with the selected ordering station 14 may be listed by a status category of in-process, pending, canceled, active, inactive, closed or denied. Step 84 allows a user to activate a link within a respective status category to access a ticket order status list for that status category for a respective ordering station 14. From the order status list a user at ordering agency 12 may activate a link in step 86 to access a ticket order information page associated with that ticket order. For example, a link may be activated for a ticket order having the status of pending and a Web page may be displayed with information associated with that ticket order. If a ticket order having a status of active is accessed the ticket log created with respect to that ticket order may be displayed. In this aspect, from the ticket log Web page a user may execute certain actions in step 88 with respect to tickets within the accessed ticket log such as crediting tickets, printing tickets or ticket receipts, for example.

A station information page accessed in step 82 may list summary information for tickets by category and the number of tickets within each category associated with ticket orders submitted from the accessed ordering station 14. For example, summary information may include categories of unassigned, name pending, assigned, canceled, reissued or credited and the total number of tickets within each category. Information with respect to transportation routes used by the ordering station 14 may be presented in the respective station information page. Route information may include a city or cites of origin and a city or cities of destination. A user at an ordering agency 12 may add or delete cities of origin and destination for an ordering station 14 in step 90 by accessing respective drop down menus populated with cities of origin and destination and selecting a city of choice. The station information page may include a menu having links to allow a user to add or delete an ordering station 14 or edit ordering station 14 information in step 92. A link to a list of carrier fares may be provided that allows a user to access in step 94 a list of carriers that provide services between cities of origin and destination and the fares each carrier charges with respect to routes between those cities. Fares and routes may be updated in real-time by a respective carrier 16.

From the main menu displayed on the interactive Web page of an ordering agency 12, a user may link to a menu of reports for generating data associated with the ordering agency 12 and respective ordering stations 14 within that agencies' area of responsibility. Step 96 allows reports to be generated and printed or presented in a separate Web browser for a user's review and may include a range of empirical data with respect to categories of information that a user may rely on in making management decisions. For example, reports may be generated for GTR activity by month, year and carrier, a list of station addresses, ticket inventory by ordering station 14, routes by ordering station 14, tickets outstanding by ordering station 14 and associated carriers, ticket order activity by date, and available routes and fares by carrier and ordering stations 14.

From the main menu displayed on the interactive Web page of an ordering agency 12, a user may link to a payment accounts list in step 98 that may list a payment method, a fund site and accounts associated with an ordering agency 12. A link may be provided to allow a user to access or create an account. A user may activate from the main menu a link for editing the ordering agency 12 profile where a user may edit contact information or add a fund profile. A link for managing security aspects may be provided in the main menu for allowing a user at an ordering agency 12 in step 100 to view and manage a list of users, add and delete users, edit user information and level of access, and perform other tasks related to the security of the system with respect to ordering agency 12.

A user at a travel center 15 may use an interactive application program via a Web browser for executing functions that may be specific to a travel center 15, which may be a location where students live to obtain an education or job training, for example. In this respect, travel arrangements may be made by travel center 15 for students entering and leaving the center 15 for various categories of travel. One aspect of the invention allows a profile to be created in step 110 for a travel center 15. The profile may include a center 15 name, address, contact information, a number of resident and non-resident students, menus for selecting a student search mode and activating/deactivating automatic email notifications. A main menu Web page displaying the profile information may also include information identifying a contractor that may manage the center 15, surface transportation providers and links for adding/removing cities of origin/destination for modes of transportation serving the travel center 15 such as airplane, bus or train, for example.

In one aspect of the invention a ticket request or order may be created in step 112 by a user at a travel center 15 and transmitted over communications medium 10 to a travel agent 17 for processing. A ticket order may be created electronically in step 112 by linking from the main menu Web page to an initial ticket order Web page that may include a menu for selecting a category of travel associated with a passenger. The initial ticket order page may include a code designating associated with the categories of travel such as “initial input” and may allow a user to select a bulk ticket order and a mode of transportation such as airplane, bus or train. A bulk order for tickets may be limited to a predetermined mode of transportation such as by bus only. After completing the initial ticket order Web page a user may link to subsequent ticket order pages for selecting a city of origin and destination and a preferred or flexible departure or return date and time. After completing these fields the ticket order may be saved in step 114 such as to database 20 and a ticket order summary may be displayed for the user's review. From the ticket order summary page a user may then activate links for editing the ticket order information or adding individual students or passengers to the ticket order in step 116 as needed. After adding at least one passenger a ticket order may be submitted to a travel agent 17 for processing.

From the main menu displayed on the interactive Web page a user at a travel center 15 may link to a ticket order status list in step 118 that may display all ticket orders associated with the center 15. Each ticket order may have a status of:

Saved—the ticket order is saved but not submitted to travel agent.

Submitted—the ticket order is submitted to travel agent.

In-Process—the ticket order is being processed by the travel agent.

Completed—the ticket order is complete.

Rejected—the ticket order could not be completed by the travel agent.

Canceled—the ticket order was canceled by the center.

The list of ticket orders may include for each order an order identification number, the cities of origin and destination, ticket type (indicates mode of transportation), whether it's a prepaid ticket, passenger count, category of travel, the status of the ticket order, and departure, return and request dates. A ticket order having the status of “saved” with a passenger count of at least one may be submitted to travel agent 17 from the ticket order status list page. In step 120 a user may access a specific ticket order by activating a link such as the order identification number to display a ticket order page containing information specific to that ticket order. From this page a user may submit the ticket order to travel agent 17 and may modify the ticket order in step 122 such as by editing the ticket order or passenger information and adding or deleting passengers, for example.

From the main menu displayed on the interactive Web page a user at a travel center 15 may link to a Web page to inquire into an itinerary or ticket order by submitting search criteria. Exemplary search criteria may be student specific, ticket order specific, date specific or travel category specific. The inquiry function allows a user to access all ticket orders associated with the search criteria and edit any such ticket order as desired such as by adding or removing passengers or submit the order to travel agent 17. The main menu may allow a user at a travel center 15 to link to a Web page in step 124 to inquire about specific carrier 16 routes serving the geographical region of that center 15. A user may enter cities of origin and destination and travel dates to generate a list of schedules for a carrier 16. A list of route schedules may be presented from which a user may select a preferred travel schedule to access a fare associated with that carrier's 16 schedule or route. A carrier 16 may be granted security access to aspects of an application program of the invention for updating its fares so that a user may have real time access to any changes in fare.

In step 126 a user at a travel center 15 may link to a Web page from the main menu to access a list of and generate reports with respect to various categories of information associated with the center 15. For example, reports may be generated with respect to carriers' 16 itineraries, detailed and summary information for travel categories, detailed and summary information for credit card transactions, scheduled arrivals and departures and a student roster. The user may also link to a maintenance Web page to perform a range of functions in step 126 such as editing the center's 15 profile, adding a carrier 16 serving that center such as a ground transportation provider, restricting arrival or departure times to and from center 15 and viewing a list of students associated with the center 15. Students may be listed as active or inactive and the student list may display information specific to each student. Links may be provided that allow a user to edit student information, view a history of that student and effect a transfer of a student from one travel center to another, for example. The history of a student may allow the user to link to all ticket orders associated with that student and edit them as desired.

One aspect of the invention allows for carriers 16, such as ground transportation providers to submit that carrier's scheduled routes for access and review by ordering agencies 12, ordering stations 14 and travel centers 15. Carrier 16 may store data indicative of its route in database 20, which may be accessed and processed by processor 22. In this respect, the scheduled routes may include cities for which carrier 16 will be providing ground transportation services and time schedules with respect to those cities. A file may be created in database 20 for each carrier 16 submitting scheduled routes. The file or files may include a population of cities located on a particular carrier or carriers 16 route or routes.

An ordering station 14 may select a valid O/D Pair from the population of cities with respect to a passenger's travel arrangements made by that ordering station 14. A ticket log may be created when a valid O/D Pair is selected. In an alternate embodiment, ordering station 14 may select an O/D Pair with respect to a passenger from a population of cities established in that station's profile. The selected O/D Pair may then be compared to a carrier's 16 route, such as by comparing the selected O/D Pair to the population of cities in database 20. This allows for determining if the selected O/D Pair is a valid O/D Pair. If the selected O/D Pair is valid then a ticket log may be created by ordering station 14. Creating a ticket log allows ordering station 14 to issue ordered tickets to passengers.

Embodiments of the invention allow for various forms of payment for tickets, ticket crediting and reconciliation of credit card and centrally billed account (CBA) payments. One method of payment may be using an account, which may be credited after tickets are purchased using that method. In this respect, tickets may be purchased and credited using this account on a monthly basis. For example, if ten tickets are purchased for $10.00 each in month A the account may be charged $100.00 for the purchase and a ticket log A may be created reflecting those purchased tickets. A credit may be made during month B for a quantity of tickets purchased in month A and reflected in ticket log A, only up to the purchase amount for a quantity of tickets charged to the account in month B. For instance, if five tickets purchased in month A, and reflected in ticket log A are to be credited in month B then five or more additional tickets would have to have been purchased in month B.

While the exemplary embodiments of the present invention have been shown and described by way of example only, numerous variations, changes and substitutions will occur to those of skill in the art without departing from the invention herein. Accordingly, it is intended that the invention be limited only by the spirit and scope of the appended claims.

1) A method of making travel arrangements among an ordering agency and a plurality of ordering stations that are interconnected in a Web-based environment over a communications medium, the method comprising:
creating a first electronic ticket order at an ordering station;
transmitting the first electronic ticket order from the ordering station to the ordering agency;
approving the first electronic ticket order at the ordering agency;
transmitting an electronic notification to the ordering station that the first electronic ticket order has been approved;
accepting the first electronic ticket order at the ordering station;
assigning a ticket to a passenger; and
printing the ticket.

2) The method of claim 1, the step of creating the first electronic ticket order comprising:
selecting a point of origin from which a passenger will be transported;
selecting a point of destination to which the passenger will be delivered;
selecting a quantity of tickets; and
selecting a carrier for transporting a passenger from the point of origin to the point of destination.

3) The method of claim 1 further comprising:
determining a status of the first electronic ticket order; and
accepting the approved first electronic ticket order at the ordering station if the determined status is pending.

4) The method of claim 1 further comprising:
generating a ticket log in response to accepting the approved first electronic ticket order.

5) The method of claim 4 further comprising:
populating the ticket log with data indicative of at least one of a ticket status, a passenger, a travel date and a route.

6) The method of claim 5 further comprising:
accessing the ticket log at the ordering station; and
assigning a ticket to a passenger.

7) The method of claim 5 wherein the ticket status displayed in the ticket log for a ticket is selected from the group of unassigned, name pending, assigned, canceled, reissued and credited.

8) The method of claim 5, the step of creating the first electronic ticket order comprising:
selecting a point of origin from which a passenger will be transported;
selecting a point of destination to which the passenger will be delivered;
selecting a quantity of tickets; and
selecting a carrier for transporting a passenger from the point of origin to the point of destination.

9) The method of claim 8 further comprising:
closing the ticket log when each ticket of the quantity of tickets has been treated with a final disposition.

10) The method of claim 1 further comprising:
creating a second electronic ticket order at the ordering station;
transmitting the second electronic ticket order from the ordering station to the ordering agency; and
approving the second electronic ticket order when the first electronic ticket order has been closed.

11) The method of claim 4 further comprising:
populating the ticket log with data indicative of a quantity of tickets ordered, a quantity of tickets used and a quantity of tickets available.

12) The method of claim 11 further comprising:
accessing the ticket log at the ordering station; and
performing at least one action with respect to a ticket selected from the group of issuing a ticket, canceling a ticket and printing a ticket.

13) The method of claim 1 further comprising:
accessing a list of ticket logs associated with respective electronic ticket orders transmitted from the ordering station to the ordering agency;
accessing a ticket log from the list of ticket logs; and
performing at least one action with respect to a ticket selected from the group of issuing a ticket, canceling a ticket and printing a ticket.

14) The method of claim 1 further comprising:
accessing a capacity control module from the ordering station;
selecting a data and a schedule for a carrier providing transportation services from a point of origin to a point of destination with respect to the ordering station; and
accessing data indicative of a number of passengers the carrier is scheduled to transport between the point of origin and the point of destination.

15) The method of claim 1, the step of creating the first electronic ticket order comprising:
selecting a point of origin from which a passenger will be transported;
selecting a point of destination to which the passenger will be delivered;
selecting a carrier for transporting the passenger from the point of origin to the point of destination;
creating an electronic manifest containing the point of origin, point of destination, the passenger's name and a time the passenger is scheduled for pickup at the point of origin; and
transmitting the electronic manifest to the carrier.

16) The method of claim 1 further comprising:
generating a ticket log in response to accepting the approved first electronic ticket order;
reserving a budget amount based on a ticket price and a quantity of tickets in the first electronic ticket order; and
charging a credit card associated an amount equal to the reserved budget amount.

17) The method of claim 16 further comprising:
populating the ticket log with data indicative of at least one of a ticket status, a passenger, a travel date and a route;
accessing the ticket log at the ordering station; and
assigning a ticket to a passenger.

18) The method of claim 1 further comprising:
accessing an electronic ticket order status list; and
accessing a ticket log from the ticket order status list wherein the ticket log is associated with an electronic ticket order transmitted from an ordering station to the ordering agency.

19) The method of claim 18 further comprising:
crediting a ticket in the ticket log.

20) The method of claim 1 further comprising:
accessing a list of ordering stations for which an ordering agency has budget authority;
accessing an ordering station information page from the list of ordering stations; and
accessing a ticket order status list.
